(19) United States
(12) Patent Application Publication
(10) Pub. No.: US 2026/0295790 A1
(43) Pub. Date: Oct. 1, 2026

(54) METHOD FOR CONTROLLING A FASTENER DRIVING TOOL

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 19/218,713

(22) Filed: May 27, 2025

(30) Foreign Application Priority Data
Mar. 26, 2025 (CN) 2025103699603

(51) Int. Cl. B25C 1/04

(52) U.S. Cl. CPC B25C 1/041; B25C 1/047

(57) ABSTRACT

A method of controlling a fastener driving tool, which relates to power tools, including a power source, a control module, a cylinder assembly, a drive assembly, a guide, a striker, a feed assembly, and a holding assembly, the drive assembly includes a motor which is a three-phase brushless motor and electrically connected to the power source via a control circuit, and a linear movement converting unit; the fastener driving tool operates with an operating cycle; after the tool is initiated, the control circuit obtains a motor speed using a sensorless algorithm and feeds it back to the control module; the control module determines an instant stage of the operating cycle as per motor speed change; the control module commands the motor to stop upon end of the operating cycle. The disclosure realizes detection and control of the operating cycle without a sensor, ensuring tool control stability and preventing tool failure.

### FIELD

The subject matter described herein relates to power tools, and more particularly relates to a method for controlling a fastener driving tool.

### BACKGROUND

A nail gun is a handheld nail driving tool widely applied in furniture manufacturing and decor industries. Nail guns generally leverage a fast-moving striker to drive a nail into a workpiece such as wood. As per their power source, nail guns can be classified into types of electric nail guns, pneumatic nail guns, manual nail guns, and fuel-powered nail guns. In an existing dual-cylinder dual-piston pneumatic nail gun, the large piston in the larger cylinder moves to compress air in the larger cylinder to a predetermined extent, which causes release of the small piston in the smaller cylinder, whereby the compressed air in the larger cylinder flows through a channel into the smaller cylinder to push the small piston in the smaller cylinder to move at high velocity, the fast-moving small piston drives the striker to move synchronously, and then the fast-moving striker drives a nail into a workpiece such as wood, thusly implementing nail driving.

A single nail-driving process of the nail gun is referred to an operating cycle. To control the operating cycle of a nail gun, conventional technologies (e.g., U.S. Pat. Nos. 8,079,504B1 and 8,800,834B2) generally provide a solution of installing a sensor in the nail gun to detect an instant position of the large piston or another moving member, and leveraging a control module to identify the position of the large piston based on a sensing signal fed back from the sensor to thereby determine an instant stage of the operating cycle. To meet detection requirements, the sensor may adopt a magnetic sensor, with a magnet attached on a corresponding moving member, where the magnetic sensor would feed a different signal back to the control module as the magnetic-field intensity the magnet changes, so that the control module determines an instant stage of the operating cycle based on the signal change fed back from the magnetic sensor. However, since the operating nail gun would generate a strong vibration, the sensor is prone to being broken or having its pins falling off; this likely causes control instability and operation failure.

### SUMMARY

To overcome the above and other drawbacks of conventional technologies, the present disclosure offers a method of controlling a fastener driving tool, which can realize detection and control of an operating cycle without a sensor to ensure tool control stability and prevents tool failures.

A method of controlling a fastener driving tool is described, in which the fastener driving tool comprises:
a power source;
a control module electrically connected to the power source;
a cylinder assembly comprising a first cylinder, a second cylinder pneumatically connected to the first cylinder, a first piston which is reciprocally movable and disposed in the first cylinder, and a second piston which is reciprocally movable and disposed in the second cylinder, the first piston defining an air chamber in the first cylinder, the air chamber being configurable to accommodate air;
a drive assembly comprising an electric motor and a linear movement converting unit, the electric motor being electrically connected to the power source and controlled by the control module, the linear movement converting unit being driven by the electric motor and linked to the first piston;
a guide which is disposed under the cylinder assembly and provided with a channel for receiving a fastener;
a striker, an upper end of which is linked to the second piston, a lower end of which acts to drive the fastener in the channel into a workpiece, the striker and the second piston having an upper initial position and a lower end position;
a feed assembly configured to feed the fastener into the channel of the guide;
and a holding assembly, which holds the second piston and the striker to the initial position before the air chamber is compressed to a predetermined ratio, the second piston and the striker released by the holding assembly moving from the initial position to the end position;
wherein the fastener driving tool operates with an operating cycle;
the electric motor adopts a three-phase brushless motor, the electric motor being electrically connected to the power source and being electrically connected, via a control circuit, to the control module;
and after the fastener driving tool is initiated, the control circuit obtains a rotational speed of the electric motor using a sensorless algorithm and feeds the rotational speed back to the control module, the control module determines an instant stage of the operating cycle as per speed change of the electric motor, and the control module commands the electric motor to stop upon end of the operating cycle.

In some implementations, the control circuit has a low voltage protection unit, and the control module stops activating the electric motor when a supply voltage of the power source is lower than a minimum working voltage Uₘᵢₙ.

In some implementations, the fastener driving tool is provided with an alert module electrically connected to the control module, and the control module commands the alert module to issue an alert when the supply voltage of the power source is lower than the minimum working voltage Uₘᵢₙ.

In some implementations, the control circuit is provided with a current detector configured to detect current of the electric motor, and the control circuit feeds a detected current signal of the electric motor back to the control module, wherein current signal change of the electric motor serves as an auxiliary factor for the control module to determine an instant stage of the operating cycle.

In some implementations, the control module commands the electric motor to stop when the current of the electric motor exceeds a preset maximum current value I₀.

In some implementations, the fastener driving tool is provided with a main switch and a safety switch, and the control module initiates the operating cycle when the main switch and the safety switch are both triggered.

In some implementations, the operating cycle comprises a compression phase in which the first piston moves upward from a stop position to a limit position and a retraction phase in which the first piston moves downward from the limit position to the stop position, the compression phase including an initiation stage, a compression stage, and a firing stage, the retraction phase including a return stage and a stop stage.

In some implementations, the rotational speed of the electric motor rises from 0 to maximum speed Rₘₐₓ in the initiation stage, and the rotational speed of the electric motor drops from the maximum speed Rₘₐₓ to R₁ in the compression stage, where R₁/Rₘₐₓ is in a range from 0.2 to 0.9.

In some implementations, the holding assembly releases the second piston and the striker when the first piston compresses the air in the air chamber at a ratio of at least 3:1.

In some implementations, the power source adopts a battery pack.

With the technical solutions noted supra, the present disclosure offers the following benefits:

1. In the method of controlling a fastener driving tool described herein, the electric motor adopts a three-phase brushless motor; when the electric motor is operating, the control circuit may obtain a rotational speed of the electric motor using a sensorless algorithm such as a back-EMF method and a sliding mode observer method and feed it back to the control module; since reciprocating movement of the first piston within an operating cycle induces volume change of the air chamber, the air pressure in the air chamber also changes along therewith, leading to change of the driving load of the electric motor within the operating cycle, while the driving load change further induces corresponding speed change of the electric motor within the operating circle; as such, the control moule can determine an instant stage of the operating cycle based on speed change of the electric motor, whereby the control module may command the electric motor to stop promptly upon end of the operating cycle. The control method described herein realizes detection and control of the operating cycle without a sensor, which ensures tool control stability and prevents tool failure.

### BRIEF DESCRIPTION OF THE DRAWINGS

FIG. 1 is an overall view of a fastener driving tool in a first implementation;

FIG. 2 is an internal structural view of the fastener driving tool in the first implementation;

FIG. 3 is a structural view of a cylinder assembly of the fastener driving tool when a first piston is disposed at a stop position while a second piston is disposed at an initial position in the first implementation;

FIG. 4 is a structural view of a cylinder assembly of the fastener driving tool when the first piston is disposed at a limit position while the second piston is disposed at a stop position in the first implementation;

FIG. 5 is a structural view of fitting between a portion of members of a holding assembly and the second cylinder of the fastener driving tool in the first implementation;

FIG. 6 is a structural view of a drive assembly of the fastener driving tool in the first implementation;

FIG. 7 is a structural view of a guide of the fastener driving tool in the first implementation;

FIG. 8 is a structural view of a safety ejector pin assembly of the fastener driving tool in the first implementation;

FIG. 9 is a schematic diagram of an operating cycle of the fastener driving tool in the first implementation;

FIG. 10 is a circuit connection diagram of the fastener driving tool in the first implementation;

FIG. 11 is a spline diagram of motor speed change against time within one operating cycle in the first implementation;

FIG. 12 is a spline diagram of motor current change against time within one operating cycle in the first implementation.

In the drawings: 10—fastener driving tool;
100—power source; 110—battery pack;
210—control module; 220—control circuit; 221—back EMF conditioning circuit; 222—current amplification conditioning circuit (current detector); 230—main switch; 240—toggle switch; 250—voltage acquisition circuit (low-voltage protection unit); 260—alert module;
300—cylinder assembly; 310—first cylinder; 311—air inlet; 320—second cylinder; 321—vent hole; 322—exhaust hole; 330—first piston; 340—second piston; 341—shock-absorbing cushion; 350—air chamber; 360—elastic valve sleeve; 370—damping block;
400—drive assembly; 410—electric motor; 420—speed reducer; 421—output shaft; 430—linear movement converting unit; 431—crank handle; 432—connecting rod; 433—pin rod;
510—guide; 511—channel; 512—nosepiece; 513—nose cap; 514—latch; 520—base; 530—feed assembly;
600—holding assembly; 610—holder; 620—lock sleeve; 630—lock core; 631—locking groove; 640—latch fastener; 641—notch; 642—first bevel; 650—retention spring; 660—unlocking block; 661—second bevel;
700—enclosure; 710—first accommodation portion; 720—second accommodation portion; 730—handle; 740—reception part; 750—trigger; 760—manipulator;
800—striker
900—safety ejector pin assembly; 910—safety switch; 920—safety ejector pin.

### DETAILED DESCRIPTION OF EMBODIMENTS

Hereinafter, the disclosure will be further described through specific implementations with reference to the accompanying drawings. It is understood that the orientational or positional relationships indicated by the terms “upper,” “lower,” “left,” “right,” “longitudinal,” “transverse,” “inner,” “outer,” “vertical,” “horizontal,” “top,” and “bottom” refer to those orientational and positional relationships illustrated in the drawings, which are intended only for facilitating description of the disclosure and simplifying relevant depictions, but not for indicating or implying that the devices or elements compulsorily possess such specific orientations or are compulsorily configured and operated with the specific orientations; therefore, such terms should not be construed as limitations to the disclosure.

### First Implementation

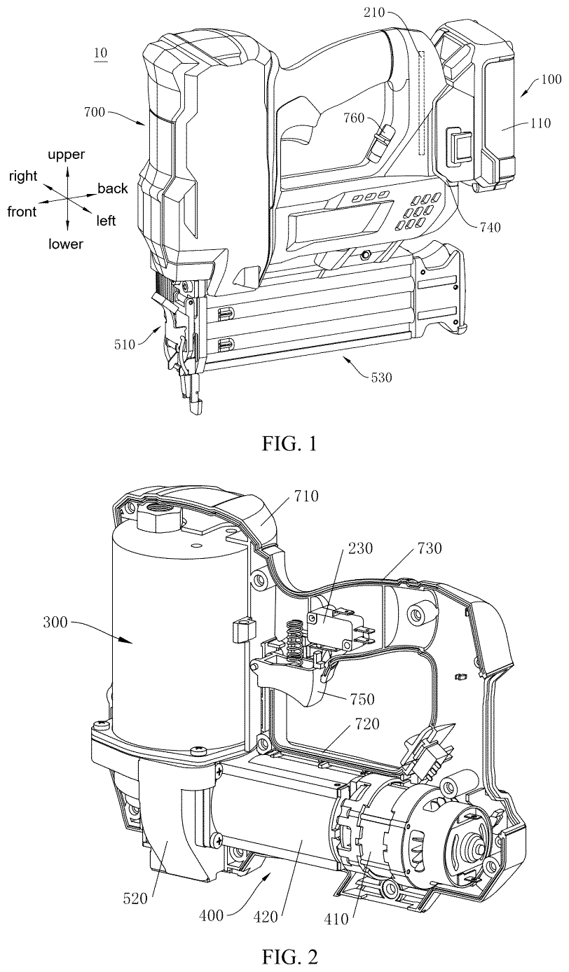

Referring to FIGS. 1 to 8, a fastener driving tool 10 according to a first implementation of the disclosure comprises:
a power source 100;
a control module 210 electrically connected to the power source 100;
a cylinder assembly 300 comprising a first cylinder 310, a second cylinder 320 pneumatically connected to the first cylinder 310, a first piston 330 which is reciprocally movable and disposed in the first cylinder 310, a second piston 340 which is reciprocally movable and disposed in the second cylinder 320, the first piston 330 defining an air chamber 350 in the first cylinder 310, the air chamber 350 being configurable to accommodate air;
a drive assembly 400 comprising an electric motor 410 and a linear movement converting unit 430, the electric motor 410 being electrically connected to the power source 100 and controlled by the control module 210, the linear movement converting unit 430 being driven by the electric motor 410 and linked to the first piston 330;
a guide 510 disposed under the cylinder assembly 300 and provided with a channel 511 configured to receive a fastener;
a striker 800, an upper end of which is linked to the second piston 340, and a lower end of which acts to drive the fastener in the channel 511 into a workpiece, the striker 800 and the second piston 340 having an upper initial position and a lower end position;
a feed assembly 530 configured to feed the fastener into the channel 511 of the guide 510;
and a holding assembly 600 which holds the second piston 340 and the striker 800 to the initial position before the air chamber 350 is compressed to a predetermined ratio, the second piston 340 and the striker 800 released by the holding assembly 600 moving from the initial position to the end position;
the electric motor 410 adopts a three-phase brushless motor, the electric motor 410 being electrically connected to the power source 100 and electrically connected, via a control circuit 220, to the control module 210;
and the fastener driving tool 10 operates with an operating cycle.

Based on the above structure of the fastener driving tool 10, this implementation provides an operating method of the fastener driving tool 10, in which the control circuit 220, after the tool is activated, obtains a rotational speed of the electric motor 410 using a sensorless algorithm and feeds it back to the control module 210, the control module 210 then determines an instant stage of the operating cycle as per speed change of the electric motor 410, and the control module 210 commands the electric motor 410 to stop upon end of the operating cycle.

Referring to FIGS. 1 and 2, in this implementation, the fastener driving tool 10 further comprises an enclosure 700 which accommodates a majority of tool components. The enclosure 700 exemplarily adopts a laterally oppositely openable housing structure, the enclosure 700 being formed with a first accommodation portion 710 configured to receive the cylinder assembly 300, a second accommodation portion 720 configured to receive the drive assembly 400, and a handle 730 available for a user to grip, the first accommodation portion 710, the second accommodation portion 720, and the handle 730 being formed integrally. The second accommodation portion 720 and the handle 730 both extend rearward from the first accommodation portion 710, the handle 730 being disposed above the second accommodation portion 720 with certain spacing therebetween. The power source 100 is exemplarily powered by the battery pack 110 so that applicable scenarios of the tool are extended; the rear end of the handle 730 is joined with the rear end of the second accommodation portion 720 and is provided with a reception part 740, the battery pack 110 being removably attached to the tool via fitting with the reception part 740, the control module 210 being arranged in a rear end of the enclosure 700 and disposed in front of the reception part 740. In an alternative solution of this implementation, the power source 100 may also be powered by mains electricity via a cord with a plug.

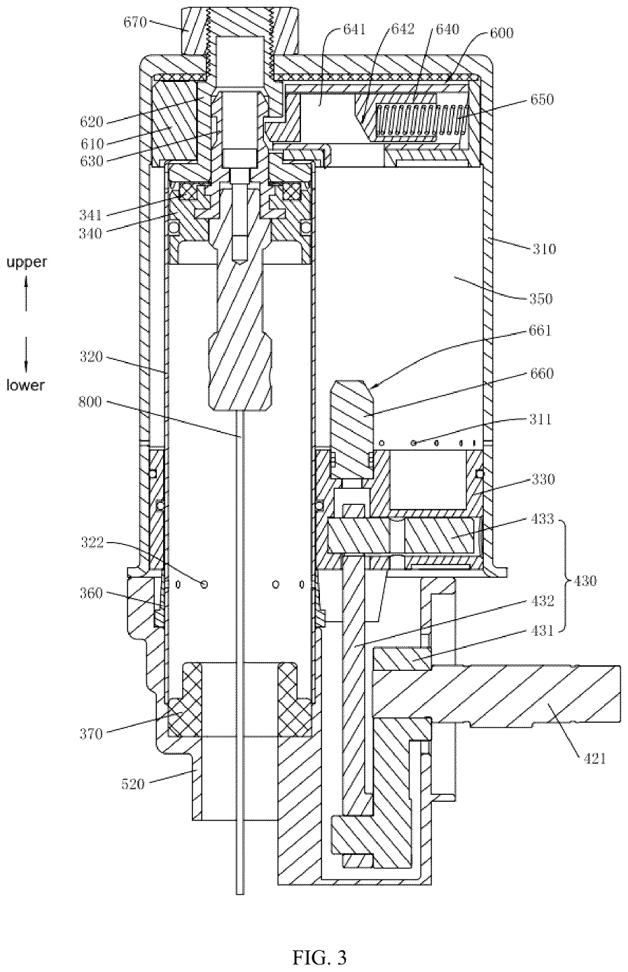

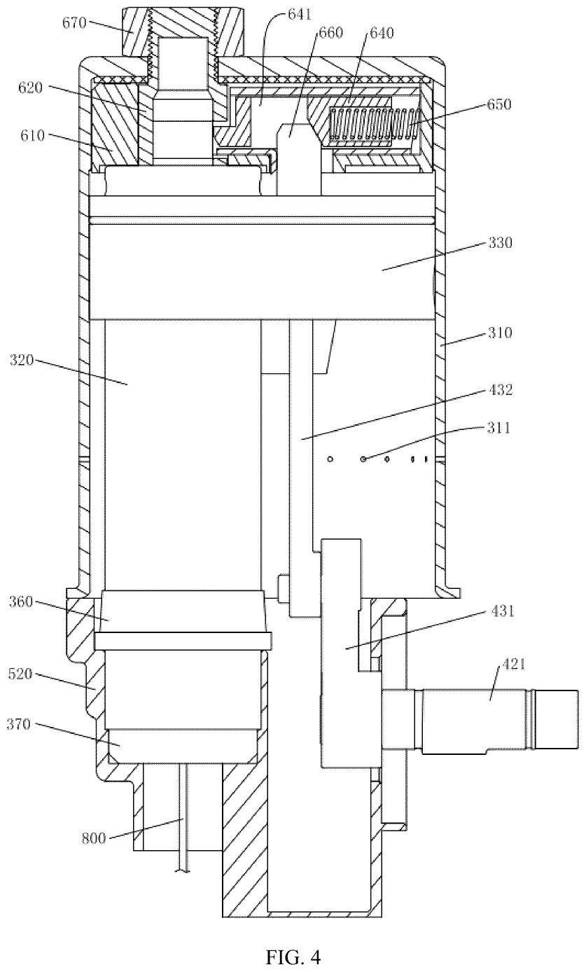

The cylinder assembly 300 is disposed in the first accommodation portion 710 of the enclosure 700 via a base 520, an axial direction of the cylinder assembly 300 being arranged in a substantially vertical manner. Referring to FIGS. 3 and 4, in this implementation, to reduce the overall size of the cylinder assembly 300, the second cylinder 320 is exemplarily disposed in the first cylinder 310. Specifically, a butt end of the first cylinder 310 abuts on the base 520, the second cylinder 320 is disposed in the first cylinder 310 and passes through the first piston 330, a lower end of the second cylinder 320 is fixedly inserted in the base 520, and the first piston 330 is movable vertically relative to the second cylinder 320. The first piston 330 maintains fitted with the first cylinder 310 in a circumferentially sealing manner, the first piston 330 also maintains fitted with the second cylinder 320 in a circumferentially sealing manner, while the second piston 340 maintains fitted with the second cylinder 320 in a circumferentially sealing manner.

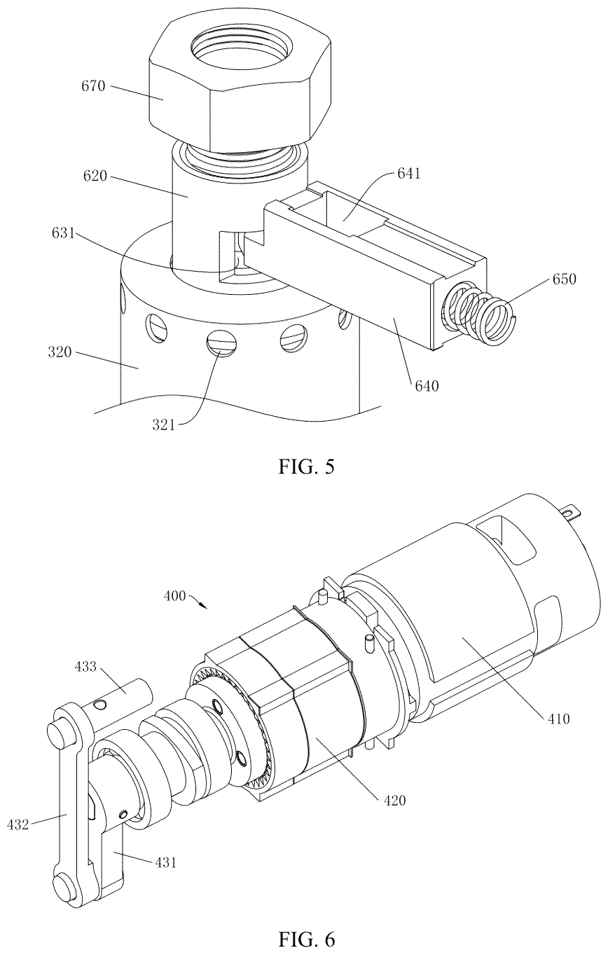

The air chamber 350 is defined by enclosure between the first piston 330 and the first cylinder 310; when the second piston 340 moves in the second cylinder 320 from the initial position to the end position, a displacement volume is created. To implement air communication between the air chamber 350 and the displacement volume, an air communication structure is arranged between the first cylinder 310 and the second cylinder 320. Referring to FIG. 5, specifically, a plurality of vent holes 321 distributed circumferentially at intervals are provided at an upper end of the second cylinder 320; when the second piston 340 is disposed at the initial position, the vent holes 321 are at least locally higher than an upper surface of the second piston 340 so that the compressed air in the air chamber 350 may directly flow through the vent holes 321 into the second cylinder 320 to act on the second piston 340, and the compressed air flowing into the second cylinder 320 serves as a gas spring to drive the second piston 340 to move the striker 800 downward from the initial position towards the end position. It may be understood that, the vent holes 321 may be set to a round shape, a square shape, a rectangular shape, an elliptical shape, an arc shape, or a triangular shape, or another reasonable shape; the vent holes 321 may also adopt various shapes simultaneously, e.g., any two or three or more types of shapes among the round shape, the square shape, the rectangular shape, the elliptical shape, the arc shape, and the triangular shape; the shapes of the vent holes 321 are not limited here. The vent holes 321 may be distributed at even intervals or at uneven intervals; distribution patterns of the vent holes 321 are not limited herein. In addition, when the second piston 340 is disposed at the initial position, a proportion of the area of the vent hole 321 disposed above the second piston 340 may be set to 50%, 55%, 60%, 65%, 70%, 75%, 80%, 85%, 90%, 95%, 100%, or other reasonable values.

A shock-absorbing cushion 341 is disposed on top of the second piston 340, and a grooved structure through which the compressed air flows is arranged on an upper surface of the shock-absorbing cushion 341, an outside diameter of the shock-absorbing cushion 341 being slightly smaller than that of the second piston 340; the compressed air flowing through the vent holes 321 into the second cylinder 320 may directly and effectively act on the second piston 340 via the grooved structure on the upper surface of the shock-absorbing cushion 341.

Referring to FIGS. 3 and 5, the holding assembly 600 comprises a holder 610 disposed on an inner top of the first cylinder 310, a lock sleeve 620 disposed on the holder 610, a lock core 630 disposed on the second piston 340 and projectable upward into the lock sleeve 620, a latch fastener 640 radially slidably disposed in the holder 610, a retention spring 650 biasing the latch fastener 640 towards the lock core 630, and an unlocking block 660 disposed on the first piston 330, the lock sleeve 620 being secured on a top wall of the first cylinder 310 via a nut 670, the lock sleeve 620 secured on top of the first cylinder 310 via the nut 670 also serving to secure the holder 610 to the inner top of the first cylinder 310. The lock core 630 is provided with a locking groove 631 in which the latch fastener 640 is partially inserted, and the lock sleeve 620 is provided with an avoidance hole corresponding to the locking groove 631. One end of the retention spring 650 is fixedly positioned, and the other end thereof abuts against the latch fastener 640; the retention spring 650 biases the latch fastener 640 towards the lock core 630 so that the latch fastener 640 is inserted in the locking groove 631 before the air in the air chamber 350 is compressed to a predetermined ratio; the insertion-fitting between the latch fastener 640 and the lock core 630 holds the second piston 340 and the striker 800 to the initial position. A notch 641 available for inserting the unlocking block 660 is arranged on the latch fastener 640, a first bevel 642 is arranged on an inner wall of the notch 641, the holder 610 is provided with a hole for avoiding the notch 641, and a second bevel 661 corresponding to the first bevel 642 is arranged at an upper end of the unlocking block 660. When the air in the air chamber 350 is compressed to a predetermined ratio, the unlocking block 660 is inserted in the notch 641, with the first bevel 642 abutting against the second bevel 661; due to abutment-fitting between the two bevels, the unlocking block 660 moving upward enables the lock fastener 640 to overcome the biasing force imposed by the retention spring 650 to move in a direction away from the lock core 630, so that the lock fastener 640 migrates out of the locking groove 631 to release the second piston 340 and the striker 800, and the released second piston 340 and striker 800 may move downward under the action of the compressed air to fire the fastener. An elastic damping block 370 is provided in a lower end of the second cylinder 320; when the second piston 340 and the striker 800 move downward till the second piston 340 engages the damping block 370, the second piston 340 and the striker 800 move to the end position.

Referring to FIG. 6, the drive assembly 400 and the cylinder assembly 300 are substantially perpendicularly arranged as to their axial directions; the drive assembly 400 comprises an electric motor 410, a speed reducer 420, and a linear movement converting unit 430, which are distributed sequentially from rear to front. A rotary shaft of the electric motor 410 projects into the speed reducer 420 to serve as a torque input element; the speed reducer 420 is provided with an output shaft 421 projecting forward into the base 520; and at least one stage of planetary gear transmission structure may be arranged inside the speed reducer 420 between the rotary shaft and the output shaft 421. The linear movement converting unit 430 comprises a crank handle 431, a connecting rod 432, and a pin rod 433, the crank handle 431 being sleeved over the output shaft 421, the pin rod 433 being disposed on the first piston 330, one end of the connecting rod 432 being hinged to the crank handle 431 while the other end thereof being hinged to the pin rod 433. The electric motor 410 outputs a torque via the output shaft 421 of the speed reducer 420, and the rotating output shaft 421 drives, via the linear movement converting unit 430, the first piston 330 to move vertically inside the first cylinder 310. In alternative solutions of this implementation, the crank handle 431 may be replaced by a cam; of course, the linear movement converting unit 430 may also be replaced by another transmission structure capable of converting a rotary movement into a reciprocal linear movement.

A plurality of air inlets 311 distributed circumferentially at intervals are provided at a lower portion of the first cylinder 310. Referring to FIG. 3, when the crank handle 431 substantially coincides with the connecting rod 432, the first piston 330 is disposed at the stop position in the first cylinder 310; now, an upper surface of the first piston 330 is lower than the air inlets 311, and the air chamber 350 communicates with the ambient air. When the drive assembly 400 drives the first piston 330 to move upward so that the upper surface of the first piston 330 is completely higher than the air inlets 311, the air chamber 350 is isolated from the ambient air. Referring to FIG. 4, when the crank handle 431 and the connecting rod 432 are disposed substantially on a same line, the first piston 330 moves in the first cylinder 310 till the limit position; now, the volume of the air chamber 350 is minimized.

A plurality of exhaust holes 322 distributed circumferentially at intervals are provided at a lower portion of the second cylinder 320, and an elastic valve sleeve 360 configurable to expose and cover the exhaust holes 322 is sleeved outside the second cylinder 320, the exhaust holes 322 and the elastic valve sleeve 360 being disposed higher than the damping block 370. During downward movement of the second piston 340 from the initial position to the end position in the second cylinder 320, the exhaust holes 322 are substantially disposed in a state of being covered by the elastic valve sleeve 360. When the second piston 340 moves till the end position, the upper surface of the second piston 340 is lower than the exhaust holes 322, so that the elastic valve sleeve 360 may expose the exhaust holes 322 under the action of air pressure difference and the air in the cylinder assembly 300 may be discharged out via the exhaust holes 322. When the air pressure in the cylinder assembly 300 becomes substantially consistent with the air pressure of the ambient air, the elastic valve sleeve 360 covers the exhaust holes 322 so that the discharge volume of the second cylinder 320 is isolated from the ambient air.

During downward movement of the first piston 330 from the limit position to the stop position in the first cylinder 310, the air pressure in the air chamber 350 drops, i.e., the cylinder assembly 300 is disposed in a negative pressure state, and the second piston 340 moves from the end position to the initial position under the action of negative pressure. Before the first piston 330 returns to the stop position, the second piston 340 first returns to the initial position where it is locked by the holding assembly 600.

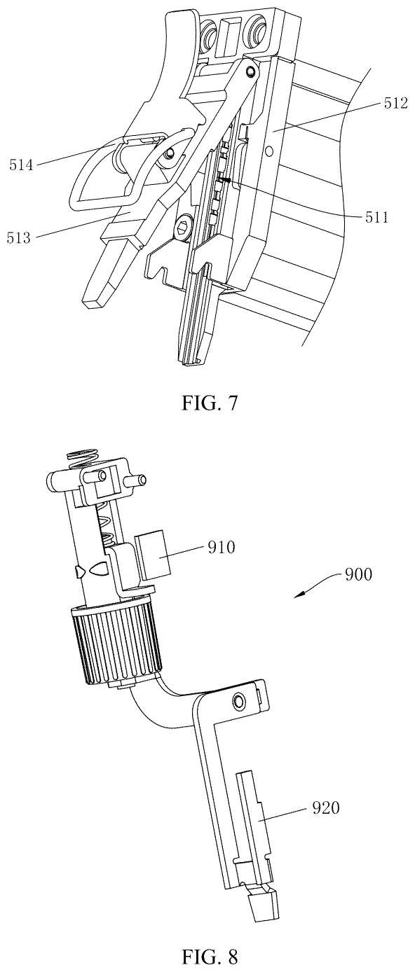

Referring to FIG. 7, the guide 510 comprises a nosepiece 512 secured to a bottom portion of the base 520, a nose cap 513 hinged to a front side of the nosepiece 512, and a latch 514 configured to lock the nose cap 513 tightly to the nosepiece 512; a channel 511 extending vertically and opened at both upper and lower ends is created when the latch 514 locks the nose cap 513 tightly to the nosepiece 512, and the downward moving striker 800 may project into the channel 511 to strike out the fastener fed into the channel 511.

Referring to FIG. 8, the tool according to this implementation further comprises a safety ejector pin assembly 900; the safety ejector pin assembly 900 comprises a safety switch 910, a safety ejector pin 920, as well as other components, the safety ejector pin 920 being disposed at a lateral side of the guide 510, a lower end of the safety ejector pin 920 protruding downward out of the guide 510; the safety switch 910 is fixedly positioned in the enclosure 700; the safety ejector pin 920 pressed against the workpiece is moved upward relative to the guide 510 so that the safety switch 910 may be triggered; other components of the safety ejector pin assembly 900 may refer to the safety ejector pin assembly disclosed in CN109623737B (or its US counterpart U.S. Pat. No. 11,478,912B2), which will not be detailed here. Of course, the safety ejector pin assembly 900 may also adopt other conventional technologies, which will not be limited here; in addition, the safety switch 910 may adopt a switch that can sense movement of the safety ejector pin 920, such as a microswitch, a magnetic sensor, or a photoelectric sensor.

A specific structure of the feed assembly 530 may refer to the nail feeding assembly disclosed in CN109623737B (or its US counterpart U.S. Pat. No. 11,478,912B2), which will not be detailed here. Of course, the feed assembly 530 for outputting fasteners may also adopt other conventional technologies, which will not be limited here.

In this implementation, a main switch 230 electrically connected to the control module 210 is provided in the handle 730, and a trigger 750 operable by a user is provided at a front end of the handle 730; when the user pulls the trigger 750, the main switch 230 is activated. To ensure operating safety of the tool, only when the safety switch 910 and the main switch 230 are both triggered, can the tool be activated.

In this implementation,the tool provides a sequential firing mode and a contact firing mode; a toggle switch 240 electrically connected to the control module 210 is provided in the enclosure 700; a manipulator 760 manipulatable by the user to switch between the firing modes is provided on the enclosure 700; the manipulator 760 may adopt a member that can satisfy mode switching requirements, such as a push block, a rotary knob, or a press button. In the sequential firing mode, it is needed to first press the safety ejector pin 920 against the workpiece to thereby trigger the safety switch 910, and then the user pulls the trigger 750 to trigger the main switch 230; the operating cycle of the tool is initiated when the safety switch 910 and the main switch 230 are both triggered. In the contact firing mode, the user may hold the trigger 750 so that the main switch 230 is in the triggered state, and then the safety ejector pin 920 is pressed against the workpiece to trigger the safety switch 910; the operating cycle of the tool is initiated when the safety switch 910 and the main switch 230 are both triggered.

When the tool is inactive, the first piston 330 is disposed at the lower stop position, and the second piston 340 is held by the holding assembly 600 to the initial position. After the tool is activated, the drive assembly 400 first drives the first piston 330 to move upward from the stop position; when the air in the air chamber 350 is compressed to a predetermined ratio, the unlocking block 660 drives the latch fastener 640 to migrate out of the lock core 630, whereby the holding assembly 600 releases the second piston 340; the compressed air in the air chamber 350 flows through the vent holes 321 into the second cylinder 320 to push the second piston 340 and the striker 800 to move downward, and the downward moving striker 800 drives the fastener in the channel 511 into the workpiece. When the second piston 340 moves to engage the damping block 370, the second piston 340 and the striker 800 move till the end position; now, the first piston 330 moves substantially till the limit position. Afterwards, the drive assembly 400 drives the first piston 330 to move downward from the limit position; during downward movement of the first piston 330 from the limit position to the stop position, a negative pressure state occurs inside the air chamber 350 and the second cylinder 320, so that the second piston 340 moves upward from the end position under the action of negative pressure. Before the air chamber 350 communicates with the ambient air via the vent holes 321, the second piston 340 returns to the initial position where it is locked by the holding assembly 600; when the first piston 320 moves till the stop position, the drive assembly 400 stops driving. Now, the tool completes one operating cycle. During the operating cycle, the first piston 330 is driven by the drive assembly 400 to move upward from the stop position to the limit position and then move back downward to the stop position.

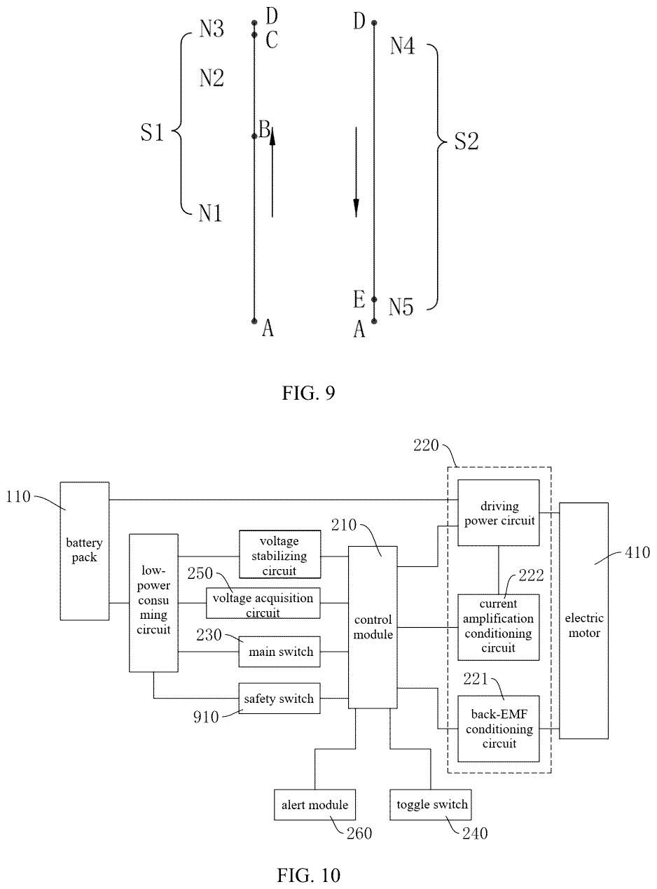

FIG. 9 illustrates the operating cycle, comprising a compression phase S1 in which the first piston 330 moves upward from the stop position to the limit position, and a retraction phase S2 in which the first piston 330 moves downward from the limit position to the stop position; specifically, the compression phase S1 further comprises an initiation stage N1, a compression stage N2, and a firing stage N3; and the retraction phase S2 comprises a return stage N4 and a stop stage N5. In FIG. 9, point A denotes the stop position of the first piston 330; point D denotes the limit position of the first piston 330; point B denotes a rough demarcation point between the initiation stage N1 and the compression stage N2; point C denotes a rough demarcation point between the compression stage N2 and the firing stage N3; and point E denotes a rough demarcation point between the return stage N4 and the stop stage N5.

Referring to FIG. 10, the control circuit 220 is provided with a back-EMF (electromotive force) conditioning circuit 221; the back-EMF conditioning circuit 221 may extract, filter, and amplify a back-EMF signal generated when the electric motor 410 is operating; a rotational speed of the electric motor 410 may be obtained using a sensorless algorithm as per a change in the back-EMF signal; the control circuit 220 feeds the speed signal, which is obtained by the back-EMF conditioning circuit 221 as per the change in the back-EMF signal, back to the control module 210, whereby the control module 210 can obtain the rotational speed of the electric motor 410 in real time; since the rotational speed of the electric motor 410 has a certain rule within an operating cycle, the control module 210 may command the electric motor 410 to stop promptly upon end of the operating cycle as per speed change of the electric motor 410. The present disclosure adopts a conventional motor speed measurement method to obtain the motor speed as per back-EMF signal change of the electric motor 410, i.e., the control circuit 220 obtains the motor speed using conventional sensorless algorithms such as a back-EMF method, a sliding mode observer method, or the like, which will not be detailed here.

In addition, the control circuit 220 exemplarily further comprises a current amplification conditioning circuit 222; the current amplification conditioning circuit 222 may serve as a current detector to obtain current of the electric motor 410 in real time; the current amplification conditioning circuit 222 feeds the obtained current signal back to the control module 210, whereby the control module 210 may obtain the current of the electric motor 410 in real time; since the driving load of the electric motor 410 has a certain rule within the operating cycle, the working current of the electric motor 410 also has a certain rule within the operating cycle, where current change of the electric motor 410 may serve as an auxiliary factor for the control module 210 to determine an instant stage of the operating cycle, which ensures that the electric motor 410 can stop promptly upon end of the operating cycle.

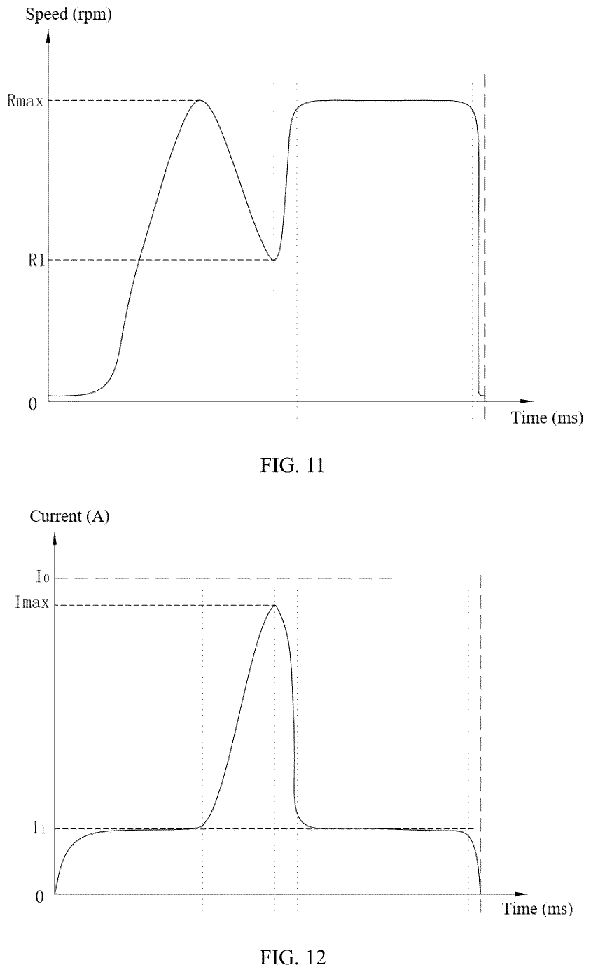

Referring to FIGS. 11 and 12, at the initiation stage N1 of the compression phase S1, since the first piston 330 just starts compressing the air in the air chamber 350, the air pressure in the air chamber 350 is still low; then the rotational speed of the electric motor 410 rises gradually from 0 till the maximum speed Rₘₐₓ; correspondingly, since the driving load of the electric motor 410 in the initiation stage N1 is still small, the current of the electric motor 410 rises from 0 to I₁.

In the compression stage N2, the air pressure in the air chamber 350 rises rapidly with reduction of the volume of the air chamber 350, and the movement resistance against the first piston 330 also increases rapidly; in this case, the rotational speed of the electric motor 410 decreases from Rₘₐₓ to R₁; correspondingly, the driving load of the electric motor 410 in the compression stage N2 increases rapidly, so that the current of the electric motor 410 increases rapidly from I₁ to Iₘₐₓ in the compression stage N2.

In the firing stage N3, the high-pressure air in the air chamber 350 flows through the vent holes 321 into the second cylinder 320 to push the second piston 340 and the striker 800 to move at high velocity from the initial position to the end position; since the second piston 340 moves at high velocity, the firing stage N3 is very short and completed substantially instantly, i.e., the electric motor 410 is suddenly offloaded in the firing stage N3; consequentially, the rotational speed of the electric motor 410 increases rapidly from R₁ to Rₘₐₓ in the firing stage N3; correspondingly, the driving load of the electric motor 410 drops rapidly in the firing stage N3, so that the current of the electric motor 410 decreases rapidly from Iₘₐₓ to I₁ in the firing stage N3.

After the first piston 330 moves to the limit position and then moves reversely downward to enter the return stage N4, since the driving load of the electric motor 410 maintains substantially stable in this stage, the rotational speed of the electric motor 410 is substantially maintained at Rₘₐₓ with the current substantially maintained at I₁. This structural design of the drive assembly 400 enables determination of the number of circles by which the electric motor 410 needs to rotate in the return stage N4 based on factors such as reduction ratio of the speed reducer 420 and movement travel of the first piston 330; in addition, the number of circles by which the electric motor needs to rotate in the return stage may be pre-written into the control module 210. The control module 210 determines an instant stage of the operating cycle as per speed change of the electric motor 410; when it is determined that the operating cycle enters the return stage N4, the control module 210 commands the electric motor 410 to stop actively after the electric motor 410 rotates by a preset number of circles.

When the first piston 330 is about to reach the stop position, the operating cycle enters the stop stage N5; the control module 210 may command the electric motor 410 to stop upon entering this stage or after the electric motor rotates by a predetermined number of circles; since the electric motor 410 performs the stop operation, the rotational speed of the electric motor 410 drops rapidly from Rₘₐₓ to 0 in this stage, and the current of the electric motor 410 also drops rapidly from I₁ to 0.

In this implementation, R₁/Rₘₐₓ is set to 0.2~0.9; specifically, R₁/Rₘₐₓ is dictated by various factors such as working voltage, working current, and rated speed of the electric motor 410, size of the air chamber, and size of the first piston 330. To ensure operating stability of the electric motor 410 and movement stability of the first piston 330, R₁/Rₘₐₓ is exemplarily set to 0.45~0.6. In this implementation, R₁/Rₘₐₓ is specifically set to 0.5. Of course, in alternative solutions of this implementations, R₁/Rₘₐₓ may also be set to other reasonable values such as 0.45, 0.47, 0.49, 0.51, 0.53, 0.55, 0.5, 0.59, and 0.6.

When the tool fails so that the electric motor 410 has an excessive driving load, the working current of the electric motor 410 likely exceeds Iₘₐₓ. To avoid burnout of the electric motor 410 due to overcurrent, the control module 210 will command the electric motor 410 to stop when the current value fed back from the current detector to the control module 210 exceeds a preset maximum current value I₀, i.e., the control module 210 may command the electric motor 410 to stop promptly when the electric motor 410 is overloaded.

The battery pack 110 supplies power to the electrical components such as the electric motor 410 and the control module 210 when the tool is operating; the control module 210 is provided with a voltage acquisition circuit 250 configured to acquire a supply voltage of the battery pack 110 in real time, and the voltage acquisition circuit 250 feeds the acquired supply voltage signal back to the control module 210. Since the supply voltage of the battery pack 110 decreases gradually after the tool operates for a period of time, in order to protect the battery pack 110, the control module 210 may stop activating the electric motor 410 when the control module 210 determines, based on the supply voltage signal fed back by the voltage acquisition circuit 250, that the supply voltage is lower than a preset minimum working voltage Uₘᵢₙ; in this case, the tool cannot initiate the operating cycle normally, and the supply voltage signal fed back from the voltage acquisition circuit 250 plays a role of low-voltage protection. Therefore, the voltage acquisition circuit 250 also serves as a low-voltage protection unit. For example, supposing the rated voltage of the battery pack 110 is 20V and the minimum working voltage Uₘᵢₙ of the battery pack 110 is 15V, when the supply voltage of the battery pack 110 is lower than 15V, the control module 210 still stops activating the electric motor 410 even if the main switch 230 and the safety switch 910 are both triggered.

To alert the user upon failure of the tool, the tool is further provided with an alert module 260 electrically connected to the control module 210, the control module 210 being configurable to command the alert module 260 to alert the user in a case of tool failure. For example, when the supply voltage of the battery pack 110 of the tool is lower than the minimum working voltage Uₘᵢₙ, or the current of the electric motor 410 exceeds the maximum current value I₀, or other faults arise, the control module 210 may command the alert module 260 to issue an alert. The alert module 260 may specifically adopt an alert lamp, a loudspeaker, or other alert manners that can attract the user's attention. In addition, different alert ways may be set to the alert module 260 dependent on failure types, e.g., the alert lamp keeps on or flickers, or different colors of alert lamps are adopted.

In this implementation, the holding assembly 600 releases the second piston 340 and the striker 800 when the first piston 330 compresses the air in the air chamber 350 at a compression ratio of at least 3:1. When the first piston 330 is disposed at the stop position, the volume of the air chamber 350 reaches the maximum V₀; when the volume of the air chamber 350 is compressed till at least V₀/3, the holding assembly 600 releases the piston, guaranteeing the effect of the compressed air driving the second piston 340 and the striker 800. In a specific solution of this implementation, the holding assembly 600 may release the second piston 340 and the striker 800 when the air chamber 350 is compressed to a reasonable ratio such as V₀/3, V₀/4, V₀/5, and V₀/6.

It may be understood that, in other solutions of this implementation, the control module 210 may also determine an instant stage of the operating cycle solely based on speed change of the electric motor 410, while the current signal of the electric motor 410 fed back from the current amplification conditioning circuit 222 only serves for determining whether the working current of the electric motor 410 exceeds the preset maximum current value I₀.

It may be understood that, in other solutions of this implementation, the second cylinder 320 may also be disposed outside the first cylinder 310.

It may be understood that, in other solutions of this implementation, the air communication structure between the first cylinder 310 and the second cylinder 320 may also be set to another structure satisfying air communication requirements, e.g., arranging a communication channel between the first cylinder 310 and the second cylinder 320, so long as the air communication requirements between the air chamber 350 and the discharge volume are satisfied.

It may be understood that, in other solutions of this implementation, the air inlets 311 on the first cylinder 310 may also be replaced by the structure disclosed in CN116160412A (or its US counterpart U.S. Ser. No. 18/432,537), e.g., a recessed groove is arranged on an inner wall of a lower end of the first cylinder 310, or a conical surface is arranged on an inner surface of the lower end of the first cylinder 310, or a plurality of notches are provided at the lower end of the first cylinder 310, so long as the air chamber 350 may communicate with the ambient air when the first piston 330 is disposed at the stop position.

It may be understood that, in other solutions of this implementation, the holding assembly 600 may also adopt other conventional structures, e.g., the magnetic latch structure disclosed in CN105339137B (or its US counterpart U.S. Pat. No. 9,662,777B2), or a structure of inserting the ball biased by the spring into the recess as disclosed in U.S. Pat. No. 8,800,834B2.

It may be understood that, in other solutions of this implementation, the holding assembly 600 may also be fitted with the striker 800 to hold the second piston 340 and the striker 800 to the initial position, e.g., the locking structure disclosed in CN217345367U (or its US counterpart US20240383115A1), or the locking device disclosed in CN109571373A (or its US counterpart U.S. Pat. No. 11,110,578B2).

In addition to the example implementations described supra, the present disclosure also has other implementations; those skilled in the art may make various changes and modifications according to the present disclosure, and such changes and modifications shall all fall within the scope limited in the appended claims without departing from the spirit of the present disclosure.

I/We claim:

1. A method of controlling a fastener driving tool, the fastener driving tool comprising:
a power source;
a control module electrically connected to the power source;
a cylinder assembly comprising a first cylinder, a second cylinder pneumatically connected to the first cylinder, a first piston which is reciprocally movable and disposed in the first cylinder, and a second piston which is reciprocally movable and disposed in the second cylinder, the first piston defining an air chamber in the first cylinder, the air chamber being configurable to accommodate air;
a drive assembly comprising an electric motor and a linear movement converting unit, the electric motor being electrically connected to the power source and controlled by the control module, the linear movement converting unit being driven by the electric motor and linked to the first piston;
a guide which is disposed under the cylinder assembly and provided with a channel for receiving a fastener;
a striker, an upper end of which is linked to the second piston, a lower end of which acts to drive the fastener in the channel into a workpiece, the striker and the second piston having an upper initial position and a lower end position;
a feed assembly configured to feed the fastener into the channel of the guide;
and a holding assembly, which holds the second piston and the striker to the initial position before the air chamber is compressed to a predetermined ratio, the second piston and the striker released by the holding assembly moving from the initial position to the end position;
wherein the fastener driving tool operates with an operating cycle;
the electric motor adopts a three-phase brushless motor, the electric motor being electrically connected to the power source and being electrically connected, via a control circuit, to the control module;
and after the fastener driving tool is initiated, the control circuit obtains a rotational speed of the electric motor using a sensorless algorithm and feeds the rotational speed back to the control module, the control module determines an instant stage of the operating cycle as per speed change of the electric motor, and the control module commands the electric motor to stop upon end of the operating cycle.

2. The method of controlling a fastener driving tool according to claim 1, wherein the control circuit has a low voltage protection unit, and the control module stops activating the electric motor when a supply voltage of the power source is lower than a minimum working voltage Uₘᵢₙ.

3. The method of controlling a fastener driving tool according to claim 2, wherein the fastener driving tool is provided with an alert module electrically connected to the control module, and the control module commands the alert module to issue an alert when the supply voltage of the power source is lower than the minimum working voltage Uₘᵢₙ.

4. The method of controlling a fastener driving tool according to claim 1, wherein the control circuit is provided with a current detector configured to detect current of the electric motor, and the control circuit feeds a detected current signal of the electric motor back to the control module, wherein current signal change of the electric motor serves as an auxiliary factor for the control module to determine an instant stage of the operating cycle.

5. The method of controlling a fastener driving tool according to claim 4, wherein the control module commands the electric motor to stop when the current of the electric motor exceeds a preset maximum current value I₀.

6. The method of controlling a fastener driving tool according to claim 1, wherein the fastener driving tool is provided with a main switch and a safety switch, and the control module initiates the operating cycle when the main switch and the safety switch are both triggered.

7. The method of controlling a fastener driving tool according to claim 1, wherein the operating cycle comprises a compression phase in which the first piston moves upward from a stop position to a limit position and a retraction phase in which the first piston moves downward from the limit position to the stop position, the compression phase including an initiation stage, a compression stage, and a firing stage, the retraction phase including a return stage and a stop stage.

8. The method of controlling a fastener driving tool according to claim 7 wherein the rotational speed of the electric motor rises from 0 to maximum speed Rₘₐₓ in the initiation stage, and the rotational speed of the electric motor drops from the maximum speed Rₘₐₓ to R₁ in the compression stage, where R₁/Rₘₐₓ is in a range from 0.2 to 0.9.

9. The method of controlling a fastener driving tool according to claim 1, wherein the holding assembly releases the second piston and the striker when the first piston compresses the air in the air chamber at a ratio of at least 3:1.

10. The method of controlling a fastener driving tool according to claim 1, wherein the power source adopts a battery pack.
